(19) United States
(12) Patent Application Publication
(10) Pub. No.: US 2010/0077716 A1
(43) Pub. Date: Apr. 1, 2010

(54) BALER WITH HYDRAULIC CLUTCH

(76) Inventor: Randy D. Sonne, Charles City, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 12/238,668

(22) Filed: Sep. 26, 2008

(51) Int. Cl. A01F 15/07; A01F 15/08

(52) U.S. Cl. 56/341; 100/88

(57) ABSTRACT

A round baler having a plurality of rolls to gather crop grasses within an interior of a housing. The baler has a belt drive roll that is connected to a belt drive gear with a belt drive clutch wherein the belt drive clutch is actuated by a hydraulic assembly. The hydraulic assembly has first and second fluid lines that go to both the belt drive clutch and hydraulic cylinders that control the tailgate such that the hydraulic assembly controls the operation of both.

### BACKGROUND OF THE INVENTION

This invention relates to round balers. More specifically, this invention relates to a control for a belt drive assembly of a round baler.

Round balers have been around for many years. Specifically, round balers traverse across the field collecting and intaking crop grasses such as corn stalks and the like and rolling them into bales of hay until the interior of the baler is full. At that time the baler indicates to a user that the bale of hay is at a predetermined size and netting is wrapped around the bale. Then the tailgate is opened and the bale of hay is deposited in the field. At that point in time the tractor and baler attached continue to traverse through the filed picking up the crop grasses to form the next bale of hay.

Currently, in a typical baler a drive chain and a belt are used to connect a plurality of rolls, or gears, that operate to intake the crop grass and form it into the bale of hay. The chain is powered by a gear box that receives a power takeoff shaft (PTO) from the tractor to provide power to the belts. Typically, a belt drive shaft is located at the top of the baler and has a belt drive clutch that is mechanically actuated and deactuated by a series of mechanical linkages and springs.

In operation as the baler traverses across the field and picks up crop grasses the rolls form the crop grasses into a bale of hay. Once the bale reaches a predetermined size the baler wraps the bale in net wrap. After being wrapped the tailgate of the baler opens and not until the tailgate is partially opened do the mechanical linkages actuate to deactuate the belt drive clutch. Meanwhile, once the tailgate it fully opened the bale rolls out of the baler.

A problem exists in that because of the delay between the beginning of opening the tailgate and the deactuation of the belt drive clutch the bale of hay continues to rotate within the baler. As a result larger crop grasses such as corn stalks and the like can catch on and tear the net wrap. Additionally, these mechanical linkages have many working parts and break down often causing for expensive repairs and unnecessary work stoppage.

Therefore, a principal object of the present invention is to provide an improved control system for actuating the belt drive.

Yet another object of the present invention is to improve the durability of a round baler.

These and other objects, features, or advantages of the present invention will become apparent from the specification and claims.

### BRIEF SUMMARY OF THE INVENTION

A round baler having a plurality of rolls to gather crop grasses within an interior of a housing having a top and a bottom wherein the bottom has an opening for receiving crop grasses. The round baler includes a belt drive roll that is rotatably connected adjacent the top of the housing and drivingly engages a belt that is connected to the plurality of rolls. A belt drive clutch has first and second clutch plates wherein the first clutch plate is secured to the belt drive roll and the second clutch plate is secured to a belt drive gear that is driven by a drive chain. When deactuated the first and second clutch plates disconnect the belt drive roll from the belt drive gear to stop rotation of the belt. A hydraulic assembly has a first hydraulic fluid line that extends therefrom and fluidly connects to the belt drive clutch such that the hydraulic assembly controls the belt drive clutch in order to control the rotation of the belt.

### BRIEF DESCRIPTION OF THE DRAWINGS

FIG. 1 is a side plan view of a round baler;

FIG. 2 is a top plan view of a round baler;

FIG. 3 is a top plan view of a round baler;

FIG. 4 is a side plan view of a round baler; and

FIG. 5 is a schematic diagram of a hydraulic assembly for a round baler.

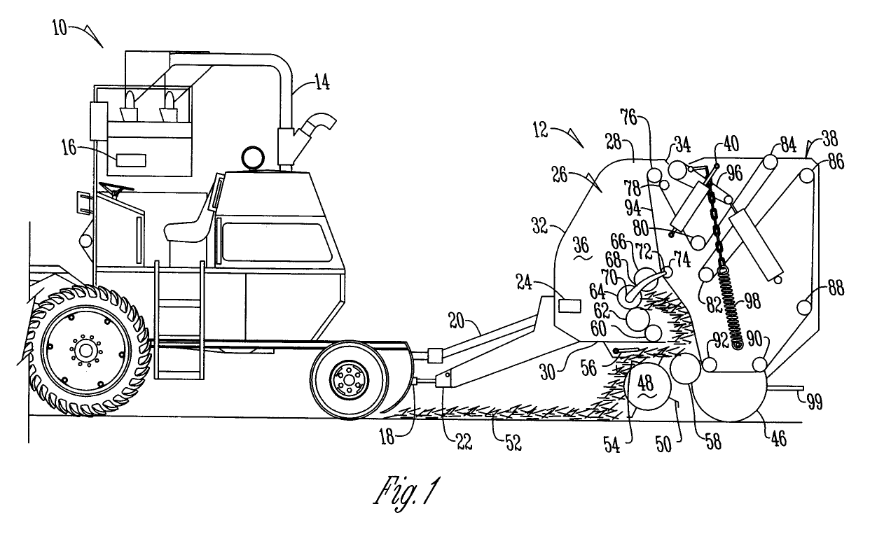

### DETAILED DESCRIPTION OF THE PREFERRED EMBODIMENT

The figures show a tractor 10 that pulls a baler 12 as the tractor traverses across a field. The tractor 10 has a cab 14 with a control panel 16 disposed therein for operating the tractor 10 and baler 12. The tractor 10 additionally has a PTO (power take off) shaft 20 extending from its engine and to the baler 12.

Baler 12 has a baler hitch 22 that connects to the tractor hitch 18 to connect the tractor 10 to the baler 12. The PTO 20 of the tractor 10 is received by a gear box 24 positioned within the housing 26 of the baler 12. The housing 26 has a top 28, bottom 30, front 32 and back 34 that form a shell around a hollow interior 36. A tailgate 38 is pivotably attached to the top 28, back 34, portion of housing 26 wherein hydraulic cylinders 40 are secured to the housing 26 and tailgate 38 in order to pivot and thus open the tailgate 38 when desired. The tailgate also encompasses the roller interior 36. Additionally, on the exterior of the housing 26 is a bottom frame 42 that contains front and back wheels 44 and 46 such that the baler 12 can traverse across the land with the tractor 10.

Within the hollow interior 36 of the housing 26 are a plurality of rolls. Specifically, underneath and adjacent the bottom 30 of housing 26 is a pickup roll 48 that has a plurality of forks or tines 50 disposed thereon for picking up crop grasses 52. The forks 50 of pickup roll 48 pull the crop grasses 52 through an opening 54 in the bottom 30 of the housing 26 through a wind guard 56. Specifically, the wind guard 56 protects the crop grasses from being blown around due to high winds.

As the crop grasses 52 enter the opening 54 the crop grasses 52 are rolled into a bale by floor roll 58, starter roll 60, stationary dimple roll 62, sledge/pivot roll 64, and stripper roll 66. A sledge/pivot arm 68 is attached to the sledge/pivot roll 64 and pivots about the roll at a first end 70 and extends to a second end 72 that has a sledge follower roll 74.

The plurality of rolls also include belt drive roll 76, back wrap roll 78, front take up roll 80, rear take up roll 82, top front tailgate idler roll 84, top rear tailgate idler roll 86, middle tailgate idler roll 88, bottom tailgate idler roll 90, tailgate nose roll 92 that are all actuated by a belt 94. Optionally a belt tension arm 96 can be used in combination with a belt tension spring 98 to provide tension to the belt when desired. Additionally, the tailgate 38 contains a bale or net wrapper 99 for wrapping the bale before a bale is to exit the baler 12.

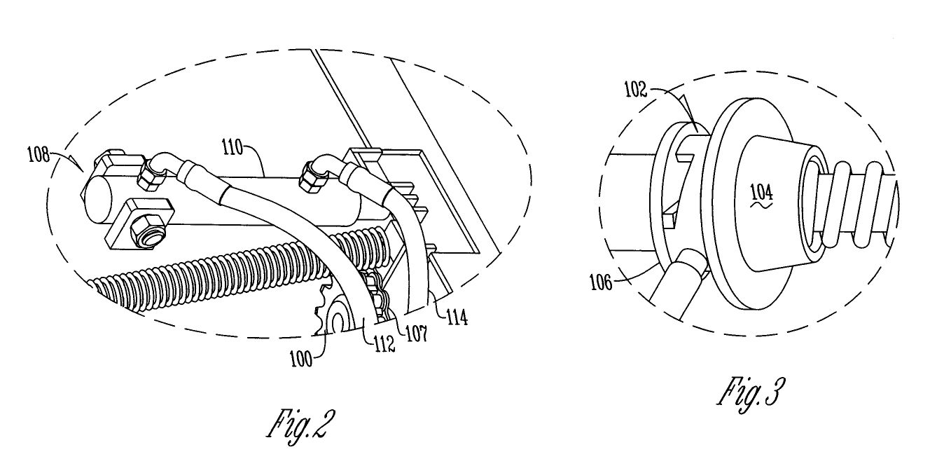

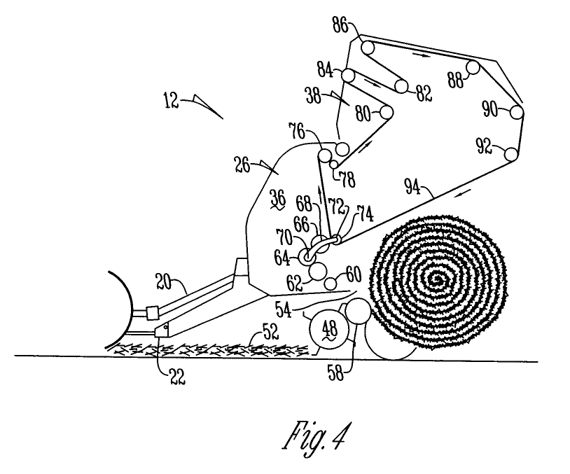

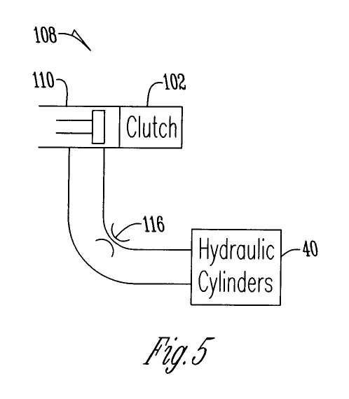

As shown in FIGS. 2 and 3 the belt drive roll 76 is connected to a belt drive shaft 100 by a belt drive clutch 102. The belt drive clutch 102 has a first clutch plate 104 and a second clutch plate 106 wherein the first clutch plate 104 is secured to the belt drive roll 76 and the second clutch plate 106 is connected to the belt drive gear 100. Specifically, the belt drive gear 100 is rotated by a drive chain 107 that is actuated by gear box 24. When actuated the first clutch plate 104 and second clutch plate 106 clutches together to connect the belt drive roll 76 to the belt drive gear 100. When deactuated the belt drive gear 100 continues to rotate however the belt drive roll 76 is no longer actuated and causes the belt 94 to stop, thus stopping movement of the plurality of rolls.

A hydraulic assembly 108 is provided for actuating the belt drive clutch 102 and hydraulic cylinders 40 of tailgate 38. Specifically, the hydraulic assembly 108 has a hydraulic actuating member 110 with hydraulic fluid lines 112 and 114 extending therefrom. In one embodiment the hydraulic actuating member 110 can be a cylinder and piston type arrangement that is fluidly connected to the belt drive clutch 102 and provides compressed fluid to actuate the belt drive clutch 102 and hydraulic cylinders 40. In a preferred embodiment a restrictor 116 is placed in a fluid line that is fluidly connected to the hydraulic cylinders 40 of the tailgate 38 in order to provide priority flow to the belt drive clutch 102. Also, in a preferred embodiment the control panel 16 is electrically connected to the hydraulic assembly 18 such that an operator of the tractor 10 can automatically control the belt drive clutch 102 and the hydraulic cylinders 40 of tailgate 38. Optionally, sensors are arranged to be in electrical communication with the control panel 16 to provide information to an operator regarding the hydraulic assembly 108.

In operation, as the tractor 10 traverses across the field and pulls the baler 12. The belt drive clutch 102 connects the belt drive roll 76 to the belt drive gear 100 to move the belt 94 along the plurality of rolls. As a result, the pickup roll 48 begins intaking crop grasses 52 into opening 54 as the plurality of rolls form the crop grasses into a bale of hay. Once a bale of hay is ready to be discharged from the baler 12 the net wrapper 99 wraps the bale. At this time the hydraulic assembly is actuated to simultaneously deactuate the belt drive clutch 102 and begin opening the tailgate 38 via the hydraulic cylinders 40. As a result the belt 94 stops movement of the plurality of rolls and the bale of hay stops rotating such that once the tailgate 38 is fully open the bale can roll out the baler 12 with minimal opportunity to tear the net wrap.

By having the hydraulic assembly 108 directly connected to the belt drive clutch 102 a simple actuating system is provided for operating the belt drive clutch 102. Because mechanical parts are eliminated, mechanical wear associated with actuating this clutch 102 is also eliminated thus providing for a longer lasting clutch and actuating system life. Additionally, because of the direct connection between the hydraulic assembly 108 and the belt drive clutch 102 an operator may quickly engage the clutch saving time when in the field. Finally, because of the electrical connection to the control panel 16 the hydraulic assembly 108 and thus the clutching and tailgate operation provide more control to an operator. Therefore, at the very least all of the stated objectives have been met.

It will be appreciated by those skilled in the art that other various modifications could be made to the device without departing from the spirit in scope of this invention. All such modifications and changes fall within the scope of the claims and are intended to be covered thereby.

1. A round baler having a plurality of rolls to gather crop grasses within an interior of a housing having a top and a bottom that has an opening therein for receiving the crop grasses comprising:
a belt drive roll rotatably connected adjacent the top of the housing and drivingly engaging a belt that is connected to the plurality of rolls;
a belt drive clutch having a first clutch plate secured to the belt drive roll and a second clutch plate secured to a belt drive gear such that when actuated the belt drive clutch connects the belt drive roll to the belt drive gear;
a hydraulic assembly fluidly connected to the belt drive clutch;
wherein actuation of the hydraulic assembly controls the belt drive clutch.

2. The round baler of claim 1 further comprising a tailgate pivotably connected to the housing.

3. The round baler of claim 2 wherein hydraulic cylinders are secured to the housing and when actuated pivots the tailgate about the housing to expose the interior of the housing.

4. The round baler of claim 3 wherein the hydraulic assembly is fluidly connected to the hydraulic cylinders via at least one hydraulic fluid line wherein the hydraulic assembly actuates the tailgate.

5. The round baler of claim 4 wherein a restrictor is disposed within a hydraulic fluid line connected to the hydraulic cylinders to provide priority to the belt drive clutch.

6. The round baler of claim 1 further comprising a control panel electrically connected to the hydraulic assembly to control actuation of the hydraulic assembly.
